(19) United States
(12) Patent Application Publication
(10) Pub. No.: US 2025/0052437 A1
(43) Pub. Date: Feb. 13, 2025

(54) Rotary Mister

(71) Applicant: Right Testing Labs, Forest Park, GA (US)

(72) Inventors: Stephen Scott Parkhurst, College Park, GA (US); Drew Matthew Mersereau, College Park, GA (US); Carl Thomas Archbold, San Diego, CA (US)

(73) Assignee: Right Testing Labs, Forest Park, GA (US)

(21) Appl. No.: 18/794,506

(22) Filed: Aug. 5, 2024

Related U.S. Application Data
(60) Provisional application No. 63/531,700, filed on Aug. 9, 2023.

(51) Int. Cl. F24F 6/16; F16C 19/06

(52) U.S. Cl. CPC F24F 6/16; F16C 19/06

(57) ABSTRACT

A rotary mister is described. The rotary mister may include a rotary movement element that is able to rotate about an axis (e.g., a linear member of the rotary mister). The rotary mister may include a fluid supply and/or output element (e.g., conduit or tubing, connectors, nozzles, etc.). The rotary mister may include a fluid dispersion element (e.g., a fan). The rotary mister of some embodiments may utilize a low-pressure supply, such as a standard water supply at standard pressure. An extended coverage area may be provided by a tube fan that rotates about the axis point.

### CROSS-REFERENCE TO RELATED APPLICATIONS

This application claims priority to U.S. Provisional Patent Application Ser. No. 63/531,700, filed on Aug. 9, 2023.

### BACKGROUND OF THE INVENTION

Many outdoor environments may be uncomfortably hot for users.

Thus, there is a need for ways to effectively and efficiently cool outdoor environments.

### BRIEF DESCRIPTION OF DRAWINGS

The novel features of the disclosure are set forth in the appended claims. However, for purposes of explanation, several embodiments are illustrated in the following drawings.

FIG. 1 illustrates a front elevation view of a pedestal rotary mister of one or more embodiments described herein;

FIG. 2 illustrates a sectional view of the pedestal rotary mister of one or more embodiments described herein;

FIG. 3 illustrates a top plan view of the pedestal rotary mister of one or more embodiments described herein;

FIG. 4 illustrates a top plan view of the pedestal rotary mister of one or more embodiments described herein during operation;

FIG. 5 illustrates a top plan view of the pedestal rotary mister of one or more embodiments described herein during rotational operation;

FIG. 6 illustrates a top plan view of a pedestal rotary mister array of one or more embodiments described herein;

FIG. 7 illustrates a top plan view of the pedestal rotary mister array of one or more embodiments described herein, where the pedestal rotary misters utilize different spray patterns;

FIG. 8 illustrates a top plan view of the pedestal rotary mister array of one or more embodiments described herein, where the pedestal rotary misters utilize overlapping spray patterns;

FIG. 9 illustrates a top plan view of a rotating feature of one or more embodiments described herein;

FIG. 10 illustrates a front elevation view of a rotational coupling feature of one or more embodiments described herein;

FIG. 11 illustrates a top plan view of the rotational coupling feature of one or more embodiments described herein;

FIG. 12 illustrates a front elevation view of a mist output and associated spray pattern of one or more embodiments described herein;

FIG. 13 illustrates a front elevation view of a mist output array and associated spray pattern of one or more embodiments described herein;

FIG. 14 illustrates a front elevation view of another mist output array and associated spray pattern of one or more embodiments described herein;

FIG. 15 illustrates a schematic block diagram of a controller of one or more embodiments described herein;

FIG. 16 illustrates a schematic block diagram of an environment of one or more embodiments described herein;

FIG. 17 illustrates a flow chart of an exemplary process that dispenses cooling mist;

FIG. 18 illustrates a flow chart of an exemplary process that adjusts mist dispensation; and

FIG. 19 illustrates a schematic block diagram of one or more exemplary devices used to implement various embodiments.

### DETAILED DESCRIPTION OF THE INVENTION

The following detailed description describes currently contemplated modes of carrying out exemplary embodiments. The description is not to be taken in a limiting sense, but is made merely for the purpose of illustrating the general principles of some embodiments, as the scope of the disclosure is best defined by the appended claims.

Various features are described below that can each be used independently of one another or in combination with other features. Broadly, some embodiments generally provide a rotary mister. The rotary mister may include a rotary movement element that is able to rotate about an axis (e.g., a linear member of the rotary mister). The rotary mister may include a fluid supply and/or output element (e.g., conduit or tubing, connectors, nozzles, etc.). The rotary mister may include a fluid dispersion element (e.g., a fan).

Existing misting systems that can cover a large area are expensive and require heavy maintenance. The current offerings of misting fans direct mist in only one direction, while oscillating fans only cover a limited range. The rotary mister of some embodiments provides a cooling solution for large areas at reduced cost and maintenance.

The rotary mister of some embodiments may utilize a low-pressure supply, such as a standard water supply at standard pressure. An extended coverage area may be provided by a tube fan that rotates three hundred sixty degrees about the axis point. In an example embodiment, a twenty-four-inch diameter fan provides approximately ten thousand cubic feet of mist per revolution (CFR). A rotary mister array of some embodiments may provide a coverage area of two thousand eight hundred square feet (or sixty feet in diameter).

Applications for the rotary mister include, for example, indoor and outdoor retail spaces, greenhouses, racetracks, remote controlled car racetracks, stadiums, golf courses, outdoor entertainment venues, retirement or nursing home patios or decks, residential patios, industrial fulfillment facilities, construction/remodeling contractor job sites, municipal street crew job sites and manufacturing line assembly facilities, among other appropriate applications.

The rotary mister may have a “pedestal” configuration in some embodiments, providing a stand-alone, free-standing floor unit. The pedestal configuration may be a very familiar orientation in multiple applications and industries of stabilizing a weight bearing base with an upward extending pole with functional apparatus coupled to top of trunk.

The rotary mister of some embodiments may include a mist dispersion element (e.g., a one-hundred-twenty-volt AC tube fan). The rotary mister may include a one-hundred-twenty-volt AC, twenty amp, five-volt DC coil single pole relay. The rotary mister may include a five-volt DC, two-amp power supply and/or a twelve-volt DC adjustable power supply. The rotary mister may include a ten amp, one-hundred-twenty-volt AC, ten-amp electrical slip ring. The rotary mister may include conduit (e.g., one-eighth-inch nylon tubing) and/or nozzles or other outputs (e.g., misting orifices having diameters between three-tenths eight-tenths of a millimeter). The rotary mister may include, for example, a one quarter inch hydraulic ball bearing swivel. The rotary mister may include a twelve-volt DC worm gear motor, a sixty tooth #25H sprocket, a ten tooth #25H sprocket, a #25H chain, a one-and-one-eighth inch spindle, and/or one quarter inch carbon steel mounting plates.

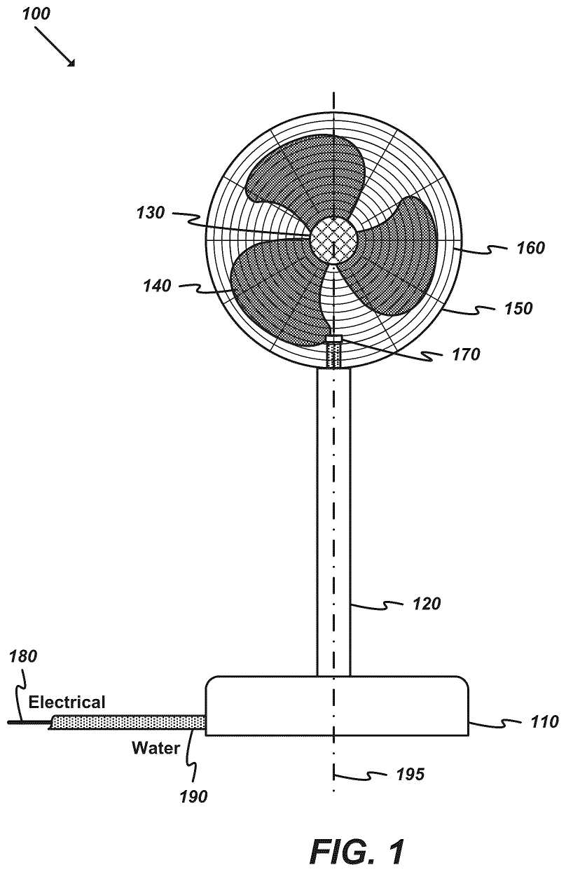

FIG. 1 illustrates a front elevation view of a pedestal rotary mister 100 of one or more embodiments described herein. As shown, the pedestal rotary mister 100 may include a base 110, a pole 120, a fan motor 130, a fan blade 140, a fan housing 150, a fan guard 160, a mist output 170, a power supply line 180, and a fluid supply line 190 (e.g., a water hose). The rotary mister 100 may rotate about a vertical (in this orientation) axis 195. Although this disclosure may include references to a pedestal configuration, the rotary mister 100 may be implemented in various different configurations or form factors in different embodiments. For example, rather than a pedestal configuration, some embodiments of the rotary mister 100 may be implemented via structural mounting features. For example, a rotary mister 100 may be coupled to a ceiling, floor, and/or other structure or support (e.g., via a pole receptacle or coupling).

Base 110 may include a housing, structural coupling components (e.g., a receptacle for pole 120), and/or other appropriate elements (e.g., a weight or ballast may prevent unwanted movement of the rotary mister 100). The base 100 may house, support, and/or otherwise couple to various other components of the rotary mister 100. In this example, the base 110 has a round shape, but the base 110 may be differently shaped and/or sized in different embodiments.

Pole 120 in this example is a cylindrical tube. Pole 120 may be extendable or telescoping in some embodiments. Pole 120 may rotate relative to base 110 and/or may allow rotation of elements housed by pole 120 (e.g., a shaft or rotor). Pole 120 may rotationally couple to base 110 via a three-hundred-sixty-degree ball bearing swivel or similar components.

Fan motor 130 may be coupled to fan blade 140 and may be able to rotate the fan blade 140 about a horizontal axis that is perpendicular to vertical axis 195. Some embodiments or rotary mister 100 may be implemented using “bladeless” fans and/or other apparatus able to move air and/or other fluids.

Fan housing 150 is a round tube in this example. Different embodiments may utilize differently shaped or otherwise differently configured fan housings 150, as appropriate (e.g., square, rectangular, oval, etc.). Fan guard 160 and/or other safety features may prevent access to the fan blade 140 when in use.

The term “fan”, as used herein, may refer to the fan motor 130, fan blade 140, fan housing 150, fan guard 160, and/or other appropriate components associated with a fan or pedestal fan.

Mist output 170 may couple to water supply 190 (e.g., via connectors, conduit, etc.) and may generate mist from the supplied water. Mist output 170 may include conduit, connectors, various output elements, and/or other appropriate components. In this example, mist output 170 may include a single round output (not shown), such as a round hole having a diameter between three-tenths and eight-tenths of a millimeter. The mist output 170 may include any number of output elements (e.g., multiple round holes having a diameter between three-tenths and eight-tenths of a millimeter) that may increase pressure and generate mist from the supplied water.

Power supply line 180 may allow the rotary mister 100 to couple to a standard household supply receptacle (e.g., the power supply line 180 may include a cord and plug) and/or other appropriate power supply.

Water supply line 190 may allow the rotary mister 100 to couple to a standard water supply (e.g., via a coupling that is complementary to a hose bib) and/or other appropriate type of water supply (e.g., via a fitted connection to a pipe or similar supply).

Different embodiments of the rotary mister 100 may include various different features, as appropriate. For instance, some embodiments of the rotary mister 100 may include cooling features that may cool fluid before the fluid is distributed as mist. As another example, some embodiments of the rotary mister 100 may include connectors or other features that allow the fan to be tilted relative to the pole 120.

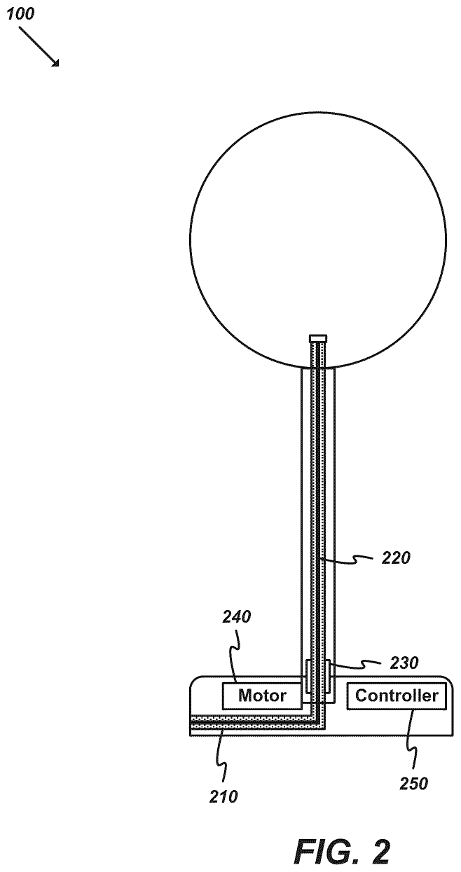

FIG. 2 illustrates a sectional view of the pedestal rotary mister 100 of one or more embodiments described herein. In this example, some of the fan components have been omitted for clarity. As shown, the pedestal rotary mister 100 may include fluid channel 210, electrical channel 220, a rotational coupling feature 230, a motor 240, and a controller 250. The pedestal rotary mister 100 may include various other components, such as user interface (UI) features (not shown) such as, for example, switches, knobs, touchscreens, displays or other indicators, microphones, speakers, buttons, keypads, etc. As another example, the pedestal rotary mister 100 may include various sensors (e.g., temperature, humidity, etc.) that may be used to manage the operation of the pedestal rotary mister 100.

Fluid channel 210 may include pipe, tubing, connectors, and/or other appropriate components. Electrical channel 220 may include wiring, connectors, contacts, and/or other appropriate components.

Rotational coupling feature 230 may allow the fluid channel 210 and electrical channel 220 to rotate three-hundred-sixty-degrees (or more). For example, rotational coupling feature 230 may include a slip ring that allows electrical channel 220 to rotate about vertical axis 195. As another example, rotation coupling feature 230 may include a three-hundred-sixty-degree hydraulic ball bearing swivel that allows fluid channel 210 to rotate about vertical axis 195. Although various discussion herein may refer to three-hundred-sixty-degree rotation, one of ordinary skill in the art will recognize that such rotation allows three-hundred-sixty-degree rotation or more (i.e., the rotating components of rotary mister 100 may be able to rotate in a same direction over any number of revolutions).

Motor 240 may couple to pole 120 (and/or other appropriate components) to generate rotational movement of the pole 120 (and/or other appropriate components).

Controller 250 may include various electronic components that are able to direct the operations of other components of the rotary mister 100, such as motor 240, fan motor 130, UI features, etc.

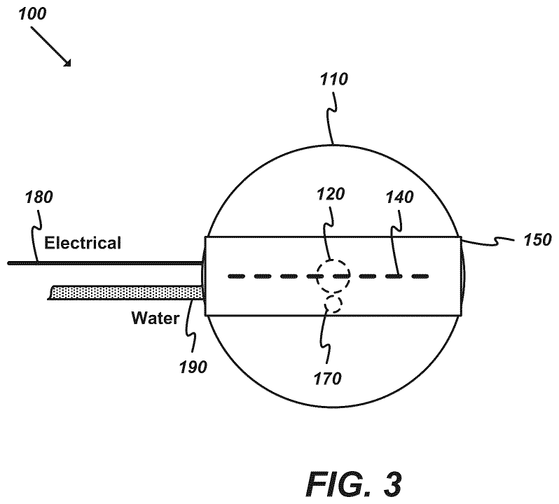

FIG. 3 illustrates a top plan view of the pedestal rotary mister 100 of one or more embodiments described herein. As shown, in this example, the mist output 170 is located at the output side of fan blade 140 (i.e., air may flow from top to bottom in this view) such that mist generated at the mist output 170 is dispersed by the output or exhaust of the rotating fan blade 140.

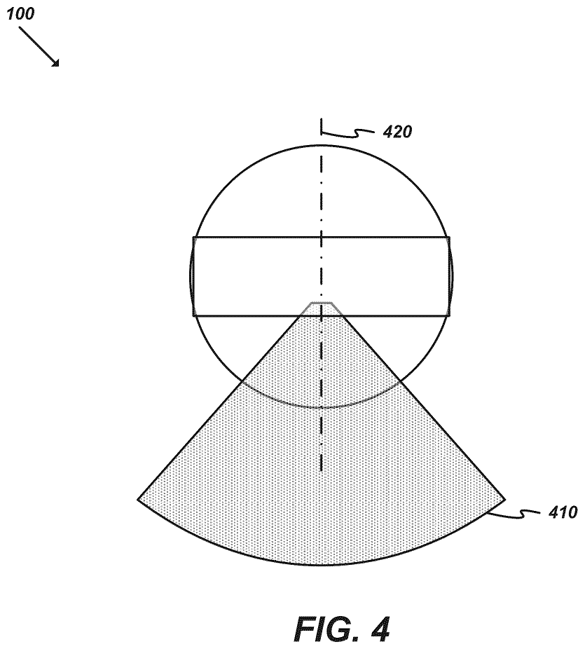

FIG. 4 illustrates a top plan view of the pedestal rotary mister 100 of one or more embodiments described herein during operation. As shown, spray pattern 410 may be generated by air flow along horizontal axis 420. Horizontal axis 420 may be perpendicular to vertical axis 195. Fan motor 130 may have a shaft that is parallel to horizontal axis 420 and fan blade 140 may rotate about horizontal axis 420. Spray pattern 410 is presented for exemplary purposes and one of ordinary skill in the art will recognize that many different spray patterns may be achieved depending on various relevant factors (e.g., fan speed, water pressure, type of mist output 170, etc.).

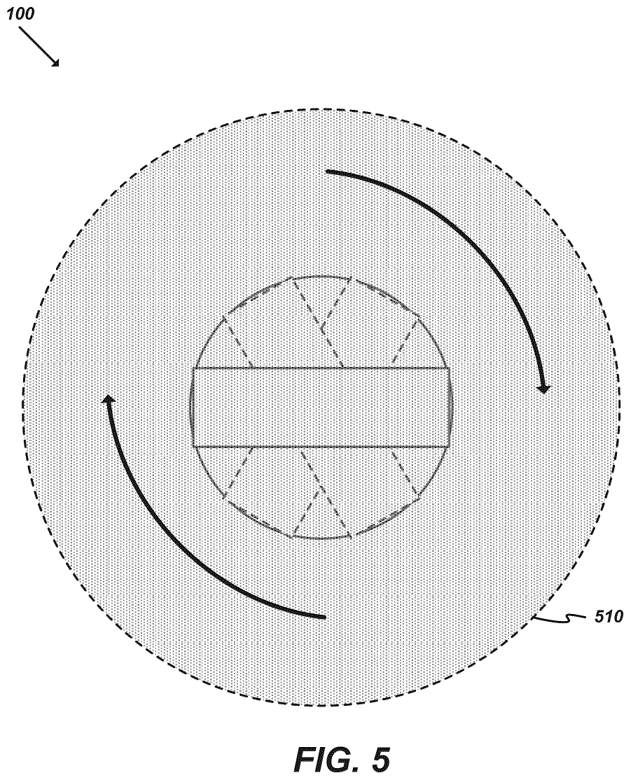

FIG. 5 illustrates a top plan view of the pedestal rotary mister 100 of one or more embodiments described herein during rotational operation. In this example, rotation about vertical axis 195 generates a spray pattern 510 covering a round area.

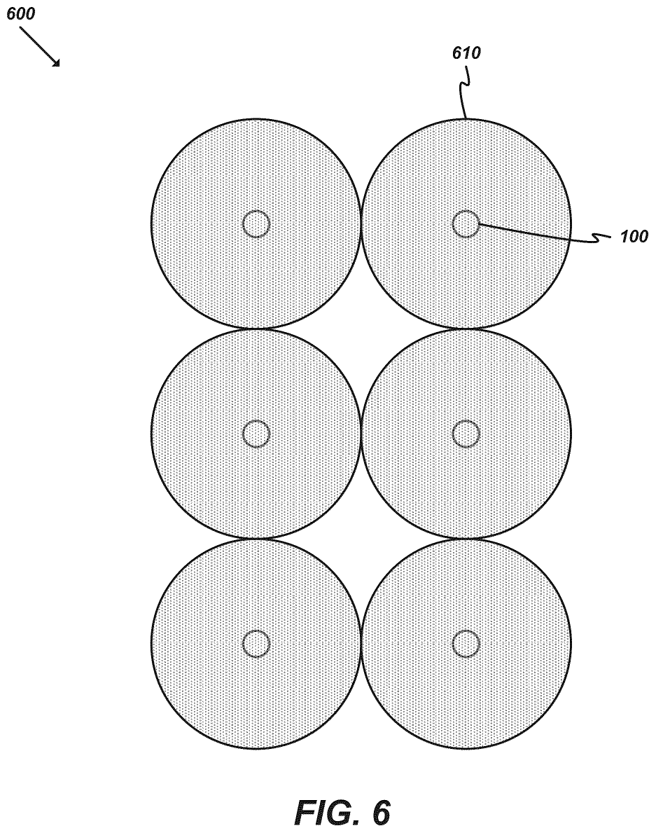

FIG. 6 illustrates a top plan view of a pedestal rotary mister array 600 of one or more embodiments described herein. As shown, multiple rotary misters 100, each with a full-rotation spray pattern 610, may be utilized in an array 600 of rows and columns that generally covers a rectangular area in this example. Different embodiments may utilize different arrays depending on various relevant factors (e.g., size and/or shape of the area to be cooled, availability of electrical or water supplies, etc.).

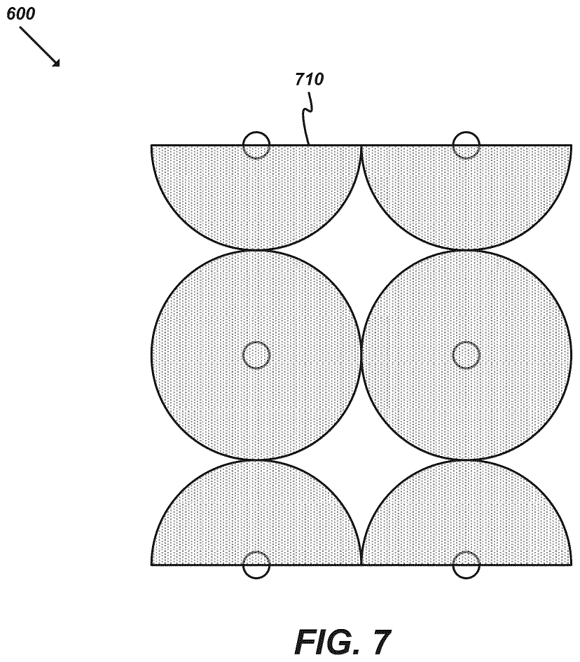

FIG. 7 illustrates a top plan view of the pedestal rotary mister array 600 of one or more embodiments described herein, where the pedestal rotary misters 100 utilize different spray patterns. In this example, rotary misters 100 at the top and bottom of the array 600 (in this view) have semicircle spray patterns 710 rather than full rotation spray patterns 610. Such spray pattern control may be used to provide coverage for differently shaped areas and/or areas associated with different physical features (e.g., walls or other structures, plants or foliage, etc.) that may not be able to receive excessive amount of water.

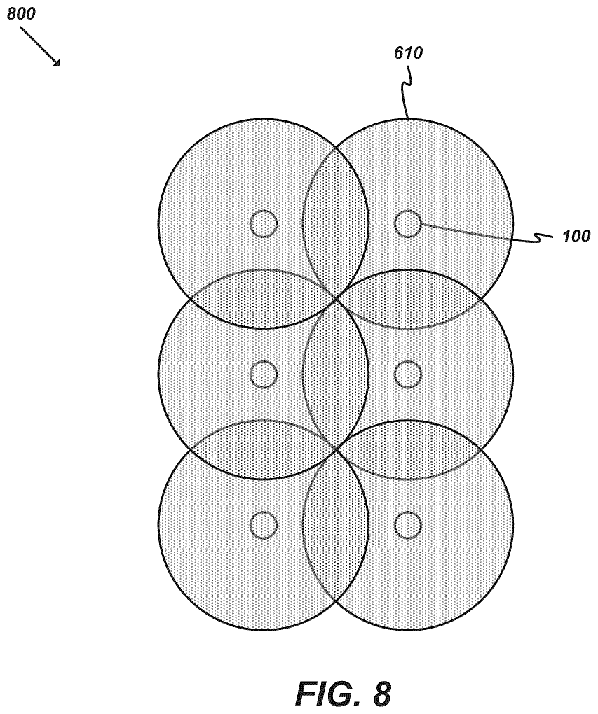

FIG. 8 illustrates a top plan view of a pedestal rotary mister array 800 of one or more embodiments described herein, where the pedestal rotary misters utilize overlapping spray patterns. As shown, multiple rotary misters 100 may be utilized in an array 800 of rows and columns that generally covers a rectangular area in this example. As shown, in this example the spray patterns 610 of the rotary misters 100 may partially overlap to reduce or eliminate any gaps in coverage.

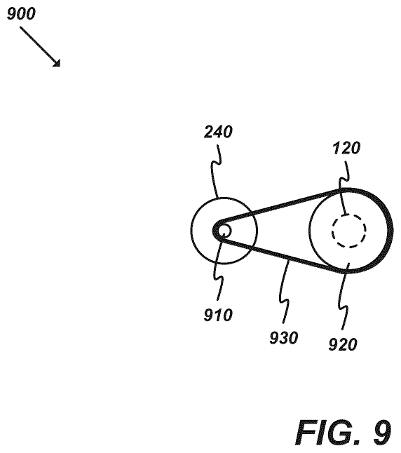

FIG. 9 illustrates a top plan view of a rotating feature 900 of one or more embodiments described herein. As shown, motor 240 may include a shaft or rotor 910 that may be coupled to a gear or similar element. Similarly, pole 120 may be coupled to a gear or similar element 920. Shaft 910 may be coupled to gear 920 via a belt, chain, or similar element 930. In some cases, the pole 120 and/or gear 920 may be coupled to the shaft 910 (e.g., via complementary gears). In any case, rotating feature 900 may cause the pole 120, the fan attached to the pole, and/or other components associated with rotary mister 100 to rotate about vertical axis 195.

Rotating feature 900 (or portions thereof) may be housed by the base 110 or fan housing 150, or may be otherwise coupled to the pole 120, base 110, and/or fan housing 150.

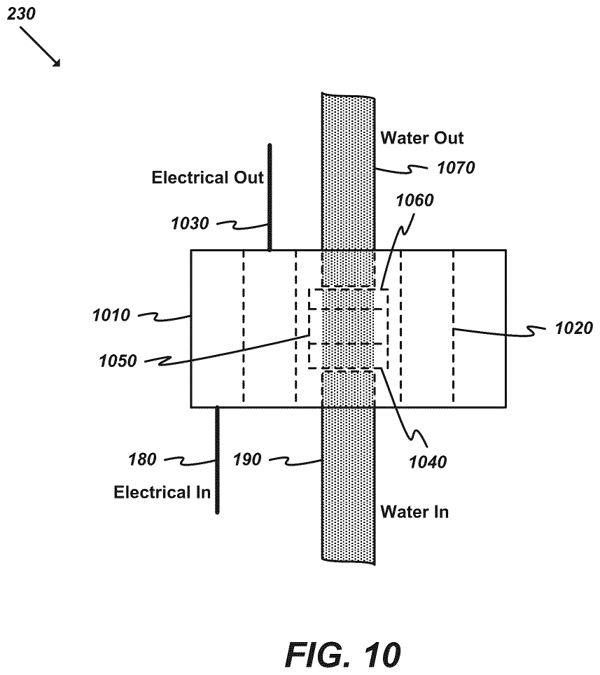

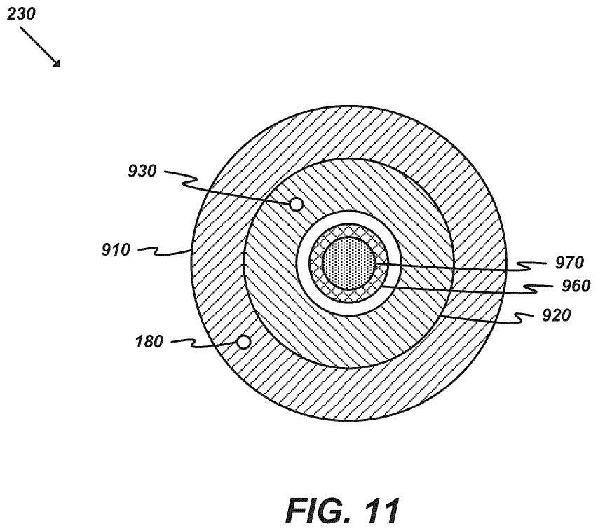

FIG. 10 illustrates a front elevation view of a rotational coupling feature 230 of one or more embodiments described herein. FIG. 11 illustrates a top plan view of the rotational coupling feature 230 of one or more embodiments described herein. The rotational coupling feature 230 may provide multiple-revolution rotation about vertical axis 195 for fluid and electrical connections.

In this example, the electrical connection may include a slip ring that may have an input portion 1010 and an output portion 1020. The input portion 1010 may receive the power supply line 180 (e.g., via a wire, contact point, and/or other appropriate connector) and provide power to the output portion 1020 which may include an output connector 1030 such as a wire, contact point etc. Output connector 1030 may be routed to elements such as the fan motor 130, motor 240 (when located at or near the fan housing 150), and/or other appropriate components. Output portion 1020 may freely rotate within input portion 1010 in this example. Different embodiments may utilize different specific slip rings and/or similar connective elements with various different configurations (e.g., the input portion may be located inside the output portion).

The fluid connection may include an input element 1040, coupling 1050, and an output element 1060. The input element 1040 may receive the fluid supply 190 and provide fluid to the output element 1060. Output element 1060 may provide fluid to output connector 1070, which may be coupled to elements such as mist output 170. Coupling 1050 may be able to rotate relative to input element 1040 and/or output element 1060.

In this example, the fluid connection runs through a channel in the center of the slip ring, but different embodiments may utilize different arrangements (e.g., the electrical connection may run through a channel in the fluid connection). In this example, there is a gap between output portion 1020 and input element 1040, coupling 1050, and output element 1060.

In some embodiments, input portion 1010 and/or input element 1040 may be coupled to base 110 (and/or other non-rotating portions of the rotary mister 100). In some embodiments, the output portion 1020 and the output element 1060 may be coupled to pole 120 (and/or other rotating portions of the rotary mister 100).

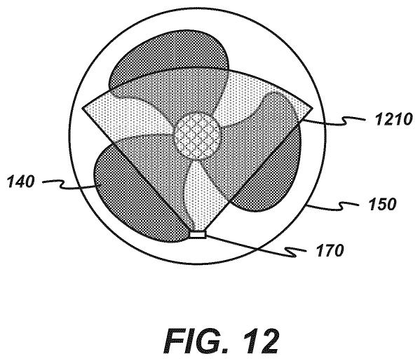

FIG. 12 illustrates a front elevation view of a mist output 170 and associated spray pattern 1210 of one or more embodiments described herein. In this example, the fan guard 160 has been omitted for clarity. Mist output(s) 170 may be located at different positions relative to the fan housing 150 and fan blade 140. For example, mist output 170 may be located at the top of the fan housing 150 and oriented downward. As another example, four mist outputs 170 may be distributed at regular intervals about the perimeter of the dan housing 150.

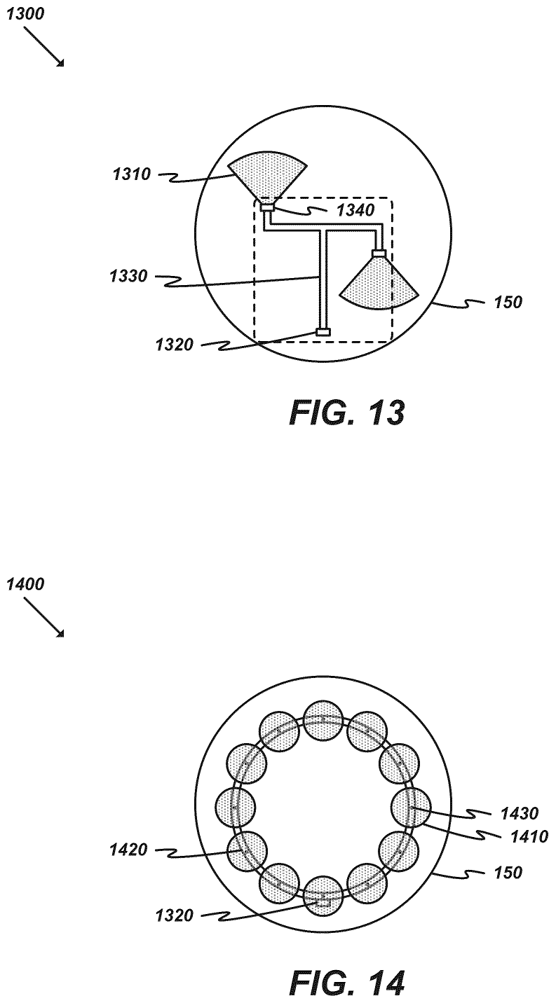

FIG. 13 illustrates a front elevation view of a mist output array 1300 and associated spray patterns 1310 of one or more embodiments described herein. In this example, mist output array 1300 may include a connector 1320, conduit 1330, and multiple mist outputs 1340. Connector 1320 may be able to couple to fluid channel 210 and provide water to conduit 1330. Conduit 1330 may include pipe, tubing, couplings, etc., and may provide water to mist outputs 1340. Each mist output 1340 may include one or more misting orifices (e.g., round holes) having diameters between three-tenths eight-tenths of a millimeter.

FIG. 14 illustrates a front elevation view of another mist output array 1400 and associated spray patterns 1410 of one or more embodiments described herein. In this example, mist output array 1400 may include a connector 1320, conduit 1420, and a set of mist outputs 1430. Conduit 1420 may include pipe, tubing, couplings, etc. In this example, conduit 1420 has a ring shape. Conduit 1420 may provide water to mist outputs 1430. Each mist output 1430 may include one or more misting orifices (e.g., round holes) having diameters between three-tenths eight-tenths of a millimeter.

One of ordinary skill in the art will recognize that different mist outputs may be arranged in various different array configurations without departing from the scope of the disclosure. For example, the size of mist outputs may be varied such that the mist outputs are larger near the top of the fan and smaller near the bottom of the fan to mitigate the effects of gravity.

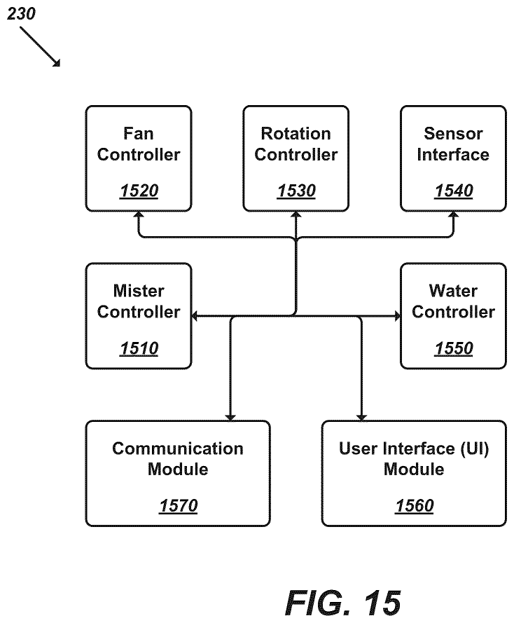

FIG. 15 illustrates a schematic block diagram of a controller 230 of one or more embodiments described herein. As shown, the controller 230 may include a mister controller 1510, a fan controller 1520, a rotation controller 1530, a sensor interface 1540, a water controller 1550, a user interface (UI) module 1560, and a communication model 1570.

The mister controller 1510 may direct operations of other components and/or implement policies and procedures related to the performance of the rotary mister 100.

The fan controller 1520 may control components of the fan, such as fan motor 130. The fan controller 1520 may be able to enable or disable the fan, and/or may control attributes such as fan speed.

The rotation controller 1530 may control rotation of the rotating elements of the rotary mister 100, such as by controlling motor 240 (e.g., by varying drive voltage, current, control signal, and/or other inputs associated with the motor 240). Rotation controller 1530 may be able to enable or disable rotation and/or may control attributes such as rotation speed, rotation range (for less than three-hundred-sixty-degree rotation), etc.

The sensor interface 1540 may allow mister controller 1510 and/or other components of rotary mister 100 to receive data from various sensors that may be associated with, included at, and/or otherwise utilized by rotary mister 100. Such sensors may include, for example environmental sensors (e.g., temperature sensors, humidity sensors, wind speed sensors, etc.), meters or other usage sensors (e.g., water flow meters, electrical use meters, etc.), cameras (e.g., to capture images and detect conditions such as cloud cover, sun intensity, etc.), rotational movement sensors (e.g., accelerometers, gyroscopes, and/or other position sensing elements), and/or other appropriate sensors. Sensors may be associated with other devices. For example, image data may be captured by a user device such as a smartphone and provided to the rotary mister 100.

The water controller 1550 may control attributes of fluid distribution. For example, the water controller 1550 may be able to control valves, pumps, or similar features that may be able to allow or prevent the flow of water into or through the rotary mister 100. As another example, the water controller 1550 may be able to control flow rate of water into or through the rotary mister 100.

The UI module 1560 may be able to receive user inputs and/or generate user outputs. For instance, the UI module 1560 may receive signals from elements such as knobs, switches, keypads, touchscreens, etc. that are associated with the rotary mister 100 (either included at the rotary mister 100 or via a connected device such as a smartphone). As another example, the UI module 1560 may generate display information related to status or performance (e.g., a display may indicate activation temperature, water usage, cooling effect or perceived cooling effect, etc.).

The communication module 1570 may allow the rotary mister 100 to communicate with other entities, such as other rotary misters 100, user devices such as smartphones, sensors, servers, etc.

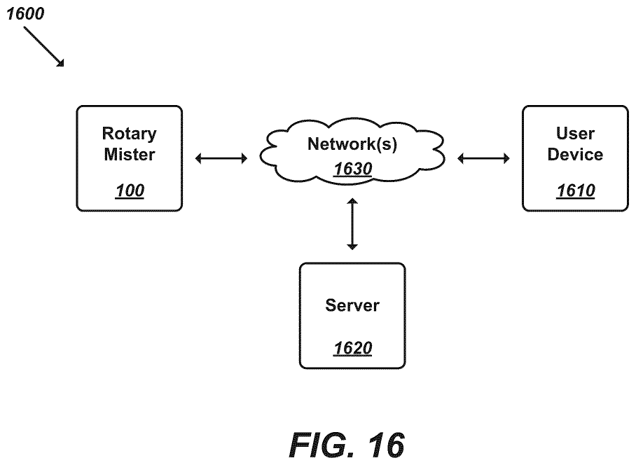

FIG. 16 illustrates a schematic block diagram of an environment 1600 of one or more embodiments described herein. As shown, environment 1600 may include rotary misters 100, user devices 1610, servers 1620, network(s) 1630, and/or other appropriate elements, components, devices, and/or systems.

Rotary mister 100 may be, include, utilize, and/or otherwise be associated with a set of electronic components, devices, systems, and/or other appropriate elements. Rotary mister 100 may include one or more processors that are able to execute instructions and/or otherwise manipulate data. Rotary mister 100 may be able to communicate via networks 1630. Rotary mister 100 may be at least partially implemented using a device such as device 1900 described below. Rotary mister 100 may be able to direct, and/or otherwise utilize, components of other devices or systems. For instance, rotary mister 100 may provide various graphical user interfaces (GUIs) via a display of user device 1610. Rotary mister 100 may include various available UI features (e.g., displays, keypads, buttons, controllers, LEDs, lights or other indicators, etc.) that may be utilized to direct the operations of the rotary mister 100. The rotary mister 100 may be able to communicate and/or otherwise interact with other rotary misters 100 (e.g., other rotary misters 100 in an array of rotary misters 100).

Each user device 1610 may be a device such as a smart phone, tablet, personal computer (PC), laptop, wearable device (e.g., a smart watch), and/or other type of device that allows user interaction with environment 1600. User device 1610 may be able to communicate via network 1630. User device 1610 may typically include various UI elements (e.g., a display, keypad, buttons, touchscreen, etc.) that may be used to provide information and/or instructions to a user and/or receive information, commands, and/or instructions from a user. User device 1610 may be implemented using a device similar to device 1900 described below.

Each server 1610 may be, include, and/or utilize a set of computing devices that may be able to execute instructions and/or otherwise process data. Server 1620 may be able to communicate via network 1630. Server 1620 may provide various resources to other components, such as application programming interfaces (APIs), database or other data storage services, etc. Server 1620 may be implemented using a device similar to device 1900 described below.

Network(s) 1630 may include various communication pathways, such as cellular networks, satellite-based systems, radio communication channels, optical communication channels, local wireless channels (e.g., Bluetooth), peer-to-peer communication channels, and/or any other available communication pathways. Information such as operating commands, firmware, operating profiles, machine learning models, and/or other relevant information may be communicated across network(s) 1630.

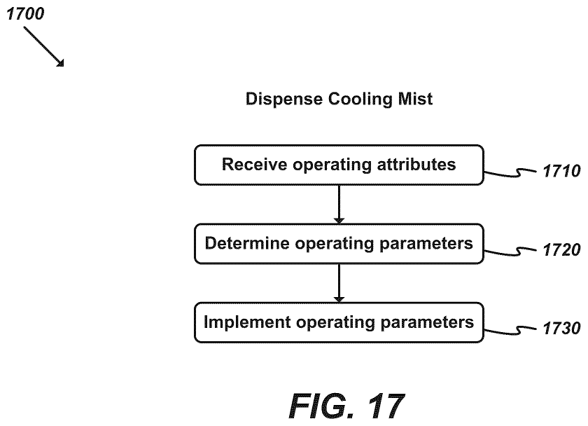

FIG. 17 illustrates an example process 1700 for dispensing cooling mist. The process may control the operation of rotary mister 100 to dispense cooling mist as directed. The process 1700 may be performed whenever rotary mister 100 is turned on or operating. In some embodiments, process 1700 may be performed by rotary mister 100, and, more specifically, by an element such as controller 230 or mister controller 1510.

As shown, process 1700 may include receiving (at 1710) operating attributes. Operating attributes may include various different elements depending on various relevant factors (e.g., specific capabilities of the rotary mister 100, user preferences, operating environment, etc.). Examples of operating attributes may include a temperature threshold (e.g., a specified temperature above which the rotary mister 100 should distribute mist), fan speed (e.g., a selection from among discrete values or along a selection along a range of values), rotation speed, water pressure, water temperature, rotation range, enabling or disabling of misting, etc. Operating attributes may be received via UI features (e.g., one or more switches, knobs, touchscreens, and/or other elements), from another device (e.g., a user device 510 or server 520), and/or may be based on default settings or values (e.g., some embodiments may simply include an on/off switch where all operating attributes are configured by default).

Process 1700 may include determining (at 1720) operating parameters. Based on the received operating attributes, the process 1700 may identify associated operating parameters using various profiles, reference tables, equations, and/or other appropriate resources or algorithms (e.g., machine learning models). For instance, a selected fan speed may be implemented by calculating or otherwise determining a drive voltage or current to be applied to fan motor 130.

The process 1700 may include implementing (at 1730) the operating parameters. Depending on the determined operating parameters, the operating parameters may be implemented in various appropriate ways. For example, by applying the calculated drive voltage or current to the fan motor 130, by opening a valve to enable misting, etc.

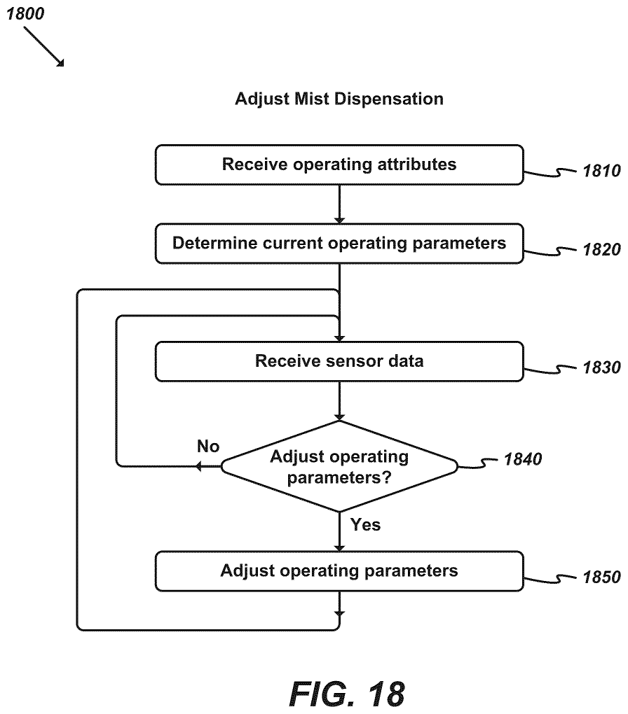

FIG. 18 illustrates an example process 1800 for adjusting mist dispensation. The process 1800 may automatically control mist dispensation based on various relevant factors (e.g., environment attributes, user selections, etc.). The process 1800 may be performed during operation of the rotary mister 100. In some embodiments, process 1800 may be performed by rotary mister 100, and, more specifically, by an element such as controller 230 or mister controller 1510.

As shown, process 1800 may include receiving (at 1810) operating attributes. Operating attributes may be received in a similar manner to that described above in reference to operation 1710.

Process 1800 may include determining (at 1820) current operating parameters. Components of controller 230, for example, may be utilized to determine various current operating parameters (e.g., fan speed, rotation speed, etc.).

The process 1800 may include receiving (at 1830) sensor data, such as environmental data (e.g., temperature). In addition to, or in place of, sensor data, the process 1800 may receive data such as user input data.

The process 1800 may include determining (at 1840) whether or not to adjust operating parameters. Based on the received sensor data (and/or other received data), the operating attributes, and/or the current operating parameters, the process 1800 may determine whether or not the operating parameters should be adjusted. Such a determination may be made in various appropriate ways. For example, sensor data may be compared to one or more specified thresholds. As one example, received or measured temperature data may be compared to a specified temperature threshold for activating (or deactivating) misting. Continuing the example, if the received or measured temperature is higher than the specified threshold, misting may be enabled (if currently disabled) or continued (of already enabled). As another example, if misting is not having the expected cooling effect, fan speed may be increased.

If process 1800 determines (at 1840) that the operating parameters should not be adjusted, process 1800 may repeat operations 1830-1840 until the process 1800 determines (at 1840) that the operating parameters should be adjusted.

If the process 1800 determines (at 1840) that the operating parameters should be adjusted, the process may include adjusting (at 1850) operating parameters. Such adjustment may include providing adjusted signals, commands, or performing other relevant actions to affect the performance of the associated components.

Operations 1830-1850 may be performed while the rotary mister 100 is active (e.g., whenever turned on). In addition, updated operating attributes may be received at any time via a resource such as UI module 1560 or communication module 1570.

One of ordinary skill in the art will recognize that processes 1700 and 1800 may be implemented in various different ways without departing from the scope of the disclosure. For instance, the elements may be implemented in a different order than shown. As another example, some embodiments may include additional elements or omit various listed elements. Elements or sets of elements may be performed iteratively and/or based on satisfaction of some performance criteria. Non-dependent elements may be performed in parallel. Elements or sets of elements may be performed continuously and/or at regular intervals.

The processes and modules described above may be at least partially implemented as software processes that may be specified as one or more sets of instructions recorded on a non-transitory storage medium. These instructions may be executed by one or more computational element(s) (e.g., microprocessors, microcontrollers, digital signal processors (DSPs), application-specific integrated circuits (ASICs), field programmable gate arrays (FPGAs), other processors, etc.) that may be included in various appropriate devices in order to perform actions specified by the instructions.

As used herein, the terms “computer-readable medium” and “non-transitory storage medium” are entirely restricted to tangible, physical objects that store information in a form that is readable by electronic devices.

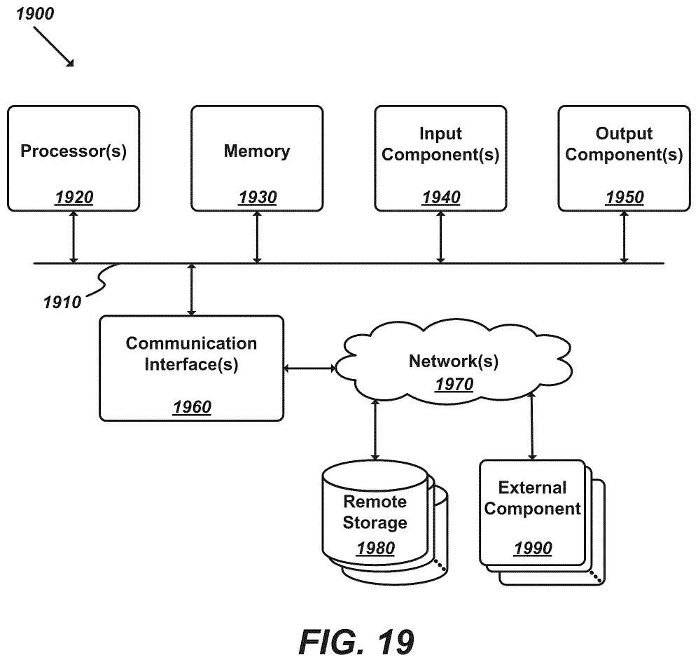

FIG. 19 illustrates a schematic block diagram of an exemplary device (or system or devices) 1900 used to implement some embodiments. For example, the systems, devices, components, and/or operations described above in reference to FIG. 1-FIG. 16 may be at least partially implemented using device 1900. As another example, the processes described in reference to FIG. 17 and FIG. 18 may be at least partially implemented using device 1900.

Device 1900 may be implemented using various appropriate elements and/or sub-devices. For instance, device 1900 may be implemented using one or more personal computers (PCs), servers, mobile devices (e.g., smartphones), tablet devices, wearable devices, and/or any other appropriate devices. The various devices may work alone (e.g., device 1900 may be implemented as a single smartphone) or in conjunction (e.g., some components of the device 1900 may be provided by a mobile device while other components are provided by a server).

As shown, device 1900 may include at least one communication bus 1910, one or more processors 1920, memory 1930, input components 1940, output components 1950, and one or more communication interfaces 1960.

Bus 1910 may include various communication pathways that allow communication among the components of device 1900. Processor 1920 may include a processor, microprocessor, microcontroller, DSP, logic circuitry, and/or other appropriate processing components that may be able to interpret and execute instructions and/or otherwise manipulate data. Memory 1930 may include dynamic and/or non-volatile memory structures and/or devices that may store data and/or instructions for use by other components of device 1900. Such a memory device 1930 may include space within a single physical memory device or spread across multiple physical memory devices.

Input components 1940 may include elements that allow a user to communicate information to the computer system and/or manipulate various operations of the system. The input components may include keyboards, cursor control devices, audio input devices and/or video input devices, touchscreens, motion sensors, etc. Output components 1950 may include displays, touchscreens, audio elements such as speakers, indicators such as light-emitting diodes (LEDs), printers, haptic or other sensory elements, etc. Some or all of the input and/or output components may be wirelessly or optically connected to the device 1900.

Device 1900 may include one or more communication interfaces 1960 that are able to connect to one or more networks 1970 or other communication pathways. For example, device 1900 may be coupled to a web server on the Internet such that a web browser executing on device 1900 may interact with the web server as a user interacts with an interface that operates in the web browser. Device 1900 may be able to access one or more remote storages 1980 and one or more external components 1990 through the communication interface 1960 and network 1970. The communication interface(s) 1960 may include one or more application programming interfaces (APIs) that may allow the device 1900 to access remote systems and/or storages and also may allow remote systems and/or storages to access device 1900 (or elements thereof).

It should be recognized by one of ordinary skill in the art that any or all of the components of computer system 1900 may be used in conjunction with some embodiments. Moreover, one of ordinary skill in the art will appreciate that many other system configurations may also be used in conjunction with some embodiments or components of some embodiments.

In addition, while the examples shown may illustrate many individual modules as separate elements, one of ordinary skill in the art would recognize that these modules may be combined into a single functional block or element. One of ordinary skill in the art would also recognize that a single module may be divided into multiple modules.

Device 1900 may perform various operations in response to processor 1920 executing software instructions stored in a computer-readable medium, such as memory 1930. Such operations may include manipulations of the output components 1950 (e.g., display of information, haptic feedback, audio outputs, etc.), communication interface 1960 (e.g., establishing a communication channel with another device or component, sending and/or receiving sets of messages, etc.), and/or other components of device 1900.

The software instructions may be read into memory 1930 from another computer-readable medium or from another device. The software instructions stored in memory 1930 may cause processor 1920 to perform processes described herein. Alternatively, hardwired circuitry and/or dedicated components (e.g., logic circuitry, ASICs, FPGAS, etc.) may be used in place of or in combination with software instructions to implement processes described herein. Thus, implementations described herein are not limited to any specific combination of hardware circuitry and software.

The actual software code or specialized control hardware used to implement an embodiment is not limiting of the embodiment. Thus, the operation and behavior of the embodiment has been described without reference to the specific software code, it being understood that software and control hardware may be implemented based on the description herein.

While certain connections or devices are shown, in practice additional, fewer, or different connections or devices may be used. Furthermore, while various devices and networks are shown separately, in practice the functionality of multiple devices may be provided by a single device or the functionality of one device may be provided by multiple devices. In addition, multiple instantiations of the illustrated networks may be included in a single network, or a particular network may include multiple networks. While some devices are shown as communicating with a network, some such devices may be incorporated, in whole or in part, as a part of the network.

Some implementations are described herein in conjunction with thresholds. To the extent that the term “greater than” (or similar terms) is used herein to describe a relationship of a value to a threshold, it is to be understood that the term “greater than or equal to” (or similar terms) could be similarly contemplated, even if not explicitly stated. Similarly, to the extent that the term “less than” (or similar terms) is used herein to describe a relationship of a value to a threshold, it is to be understood that the term “less than or equal to” (or similar terms) could be similarly contemplated, even if not explicitly stated. Further, the term “satisfying,” when used in relation to a threshold, may refer to “being greater than a threshold,” “being greater than or equal to a threshold,” “being less than a threshold,” “being less than or equal to a threshold,” or other similar terms, depending on the appropriate context.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

The foregoing relates to illustrative details of exemplary embodiments and modifications may be made without departing from the scope of the disclosure. Even though particular combinations of features are recited in the claims and/or disclosed in the specification, these combinations are not intended to limit the possible implementations of the disclosure. In fact, many of these features may be combined in ways not specifically recited in the claims and/or disclosed in the specification. For instance, although each dependent claim listed below may directly depend on only one other claim, the disclosure of the possible implementations includes each dependent claim in combination with every other claim in the claim set.

1. A rotary mister, comprising:
a rotary movement element that is able to rotate about an axis; and
a fluid dispersion element.

2. The rotary mister of claim 1, wherein the rotary movement element comprises a rotational coupling feature including an electrical channel and a fluid channel.

3. The rotary mister of claim 2, wherein the electrical channel comprises a slip ring.

4. The rotary mister of claim 3, wherein the fluid channel comprises a ball bearing swivel.

5. The rotary mister of claim 1, wherein the fluid dispersion element comprises a fan.

6. The rotary mister of claim 5, wherein the fluid dispersion element comprises a plurality of mist outputs at an output of the fan.

7. The rotary mister of claim 6, wherein each mist output comprises a round hole having a diameter between three tenths of a millimeter and eight tenths of a millimeter.

8. A pedestal rotary mister, comprising:
a pedestal base;
a pole rotationally coupled to the base such that the pole is able to perform multiple revolutions about a vertical axis;
a rotary movement element coupled to the pole, the rotary movement element able to rotate about the vertical axis;
a fan coupled to the pole; and
a mist output array located at an output of the fan.

9. The pedestal rotary mister of claim 8, wherein the rotary movement element comprises a rotational coupling feature including an electrical channel and a fluid channel.

10. The pedestal rotary mister of claim 9, wherein the electrical channel comprises a slip ring.

11. The pedestal rotary mister of claim 10, wherein the fluid channel comprises a ball bearing swivel.

12. The pedestal rotary mister of claim 11, wherein the mist output array comprises a plurality of mist outputs, and wherein each mist output in the plurality of mist outputs comprises a round hole having a diameter between three tenths of a millimeter and eight tenths of a millimeter.

13. The pedestal rotary mister of claim 8 further comprising a water supply input that includes a complementary coupling to a hose bib, wherein the water supply input is able to supply water to the mist output array.

14. The pedestal rotary mister of claim 8, wherein the rotary movement couples a motor to the pole.

15. An array of rotary misters comprising:
a plurality of rotary misters arranged in a plurality of rows and a plurality of columns,
wherein each rotary mister in the plurality of rotary misters comprises:
a rotary movement element that is able to rotate about an axis; and
a fluid dispersion element.

16. The array of rotary misters of claim 15, wherein the rotary movement element comprises a rotational coupling feature including an electrical channel and a fluid channel.

17. The array of rotary misters of claim 16, wherein the electrical channel comprises a slip ring.

18. The array of rotary misters of claim 17, wherein the fluid channel comprises a ball bearing swivel.

19. The array of rotary misters of claim 15, wherein the fluid dispersion element comprises a fan and a plurality of mist outputs at an output of the fan.

20. The array of rotary misters of claim 19, wherein each mist output comprises a round hole having a diameter between three tenths of a millimeter and eight tenths of a millimeter.
